(19) United States
(12) Patent Application Publication
(10) Pub. No.: US 2009/0298529 A1
(43) Pub. Date: Dec. 3, 2009

(54) Audio HTML (aHTML): Audio Access to Web/Data

(75) Inventor: Yogesh Dagadu Mahajan, Holtsville, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/132,291

(22) Filed: Jun. 3, 2008

(51) Int. Cl. H04M 1/00; G10L 21/00

(52) U.S. Cl. 455/550.1; 704/270; 704/E21.001

(57) ABSTRACT

A mobile communication device for allowing a user to interact with network or internet based data using only verbal communications. The mobile communication device provides the functionality to browse internet web sites and select menus items and hyperlinks by listing to a web page and speaking the identity of the menu item or the hyperlink. The mobile communication system also provides functionality to listen to email and reply to or forward the email, including adding a response by speaking to the mobile communication device. Security is also provided, when appropriate, by requiring the user to speak a predefined security phrase before listening to data designated as secure.

### TECHNICAL FIELD

The subject invention relates generally to communication devices, and more particularly to communication devices that allow web page browsing and selection based on bidirectional audio interaction.

### BACKGROUND

Communication devices such as cellular telephones have become a necessary tool carried by almost every member of modern society. The portable nature of the device has led to a market trend to make the device smaller and therefore less cumbersome to carry no matter what the dress or situation. The miniaturization of the device has continued on all fronts, the keypads as well as the display screens have been reduced to the point where they reach the limits of human physical interaction.

Another aspect of modern technology that has become a requirement of everyday life is access to the internet. Whether this interaction is using a search engine to find information on various websites, an email client to send and receive email or an instant messaging application, the consuming public demands access to the internet from every communication device. The market also demands a simple and efficient interface to allow the user to interact with the internet with a minimum of frustration or a long learning curve to becoming proficient with the device.

The intersection of these two trends has led to a situation where smaller communication devices are unable to display a typical web page because of the richness and graphical nature of the page. The typical cellular telephone display simply does not have the screen size to represent a web page without severely limiting the functionality of the web page. In another aspect, the smaller keypads, although suitable for number entry to dial a phone number are unwieldy to navigate a web page and make the selections or data entry necessary to find the required information or respond to an email.

Market demand has created the requirement for smaller communication devices with an interface capable of efficient interaction without a complex system of interaction or special tools or additional devices required to be carried along with the communication device. Another criteria has evolved with respect to the base of web pages already available on the internet. A new system of web based interaction would be impractical if it required the modification of the installed base of web pages, accordingly, there is an increasing demand for an efficient system capable of working with the installed base of web pages.

### SUMMARY

The following presents a simplified summary in order to provide a basic understanding of some aspects described herein. This summary is neither an extensive overview nor is intended to identify key/critical elements or to delineate the scope of the various aspects described herein. Its sole purpose is to present some concepts in a simplified form as a prelude to the more detailed description presented later.

A communication device is communicatively couple to a network providing access to the internet. The communication device can download web pages from the internet and parse the web pages identifying HTML tags associated with hyperlinks and menu commands. The system then replaces the identified links with audio HTML (aHTML) tags before presenting the converted web page to the audio explorer (aExplorer). The audio explorer can then “play” the web page as a series of spoken words and commands so the user can browse the web page without the requirement of directing their vision to a graphic display. Formatted text such as bold, underlined or italicized is represented as different tones with regards to normal text.

Hyperlinks can be selected by speaking the name of the link. Browsing of a web site is accomplished by an audio interaction with the audio Explorer. The user speaks the address of a web site or issues a command to do a web search for a particular string of interest. The communication device then converts the speech to text and issues the command to the appropriate application, such as a browser or an email client. Once the communication device receives the results of the request, another conversion of text to speech occurs and the communication device speaks the results to the user. This cycle of speech to text, operations, then text to speech continues until the user has completed the desired internet activity.

In a similar fashion, the audio explorer would provide the ability for the user to browse their email account listening to a reading of the email subject line and the sender's name. If interested, the user can speak a command to select the email and the audio explorer will read the email to the user. The user can then choose to respond to the email by speaking the commands necessary to reply and then speaking the body of the email. After completing the email the user can speak a command to send the email. All of these interactions can occur without the requirement for the user to view a display screen or depress keys on a keypad.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates an embodiment of a mobile communication device and system for interacting with a network and the internet by audio input and output.

FIG. 2 illustrates an embodiment of a mobile communication device and system for interacting with a network and the internet by audio input and output where an interface component allows for user input, automated input and interaction with a communication network.

FIG. 3 illustrates an embodiment of a mobile communication device and system for interacting with a network and the internet by audio input and output where an audio converter component allows for parsing a web page for HTML tags and replacing them with audio HTML (aHTML) tags.

FIG. 4 illustrates an embodiment of a mobile communication device and system for interacting with a network and the internet by audio input and output where an audio explorer component parses audio HTML, does text-to-speech and speech-to-text conversions and provides security.

FIG. 5 illustrates an embodiment of a mobile communication device and system for interacting with a network and the internet by audio input and output where an audio input/output component provides an audio transmitter and receiver.

FIG. 6 illustrates an embodiment of a mobile communication device and system for interacting with a network and the internet by audio input and output where a storage component provides storage of the audio HTML tag database and cached audio HTML web pages.

FIG. 7 illustrates a methodology of an audio input/output system where the system downloads a web page, parses the web page for HTML tags, inserts audio HTML tags where required and plays the web page to the user.

FIG. 8 illustrates a methodology of an audio input/output system where the user speaks an audio HTML command and the system converts the audio HTML command to a text command, parses a web page for a matching text command and executes a validated audio HTML web page command.

FIG. 9 illustrates a methodology of an audio input/output system where the user provides a validation phrase for comparison as a security measure before executing an audio HTML command.

FIG. 10 illustrates an embodiment of an audio input/output system depicting a user wearing different embodiments of the mobile communication device.

FIG. 11 illustrates an embodiment of an audio input/output system depicting a user wearing a wireless headset to enhance the efficiency and security of the audio input/output system.

FIG. 12 illustrates an embodiment of an audio input/output system depicting a typical computing environment.

FIG. 13 illustrates an embodiment of an audio input/output system depicting the interaction between a mobile device client and a network server.

FIG. 14 illustrates an embodiment of an audio input/output system depicting the interaction between multiple mobile device clients.

### DETAILED DESCRIPTION

Systems and methods are provided enabling the user to interact with an application such as a web browser or an email client through an audio-centric interaction between the user and the mobile communication device. It should be noted that many other web or networked based applications can replace the examples of a web browser or email client used as examples in this application. The interaction allows for the automatic downloading of web pages or email to the mobile communication device and the conversion of the data from a predominantly visually interactive media to a predominantly audio interactive media. This conversion provides for a much richer user interaction with the network or web based application without sacrificing the ability to further minimize the size of the mobile communication device.

In one aspect of the subject disclosure, the user's emails are delivered on a timed basis for presentation to the user. For example, once every ten minutes the mobile communication device can contact the email server through a network such as a cellular network and download the user's new emails. The system then parses the emails for any active links or defined commands and converts the email from text to speech. The email is then played to the user as if being read by another to someone visually impaired. Any links or commands are presented in a predefined fashion such as a particular tone indicating the words spoken until the next tone are a hyperlink. The user can hear their email and through speaking the appropriate commands can reply to the email, forward the email, delete the email and even attach files for sending with the email. In short, the user has a fully functioning email without the requirement of looking to a display to read text.

In another example, the mobile communication device can download a web page and parse the web page adding audio HTML tags to all the standard HTML tags making up the web page. The web page can then be spoken to the user allowing the user to surf the internet without the distraction of viewing a display and clicking a mouse to navigate the web page. For instance the user can listen to the text of the web page and then speak a hyperlink identified as the link to proceed to another web page associated with the information of interest to the user. It should be noted that the scope of this invention is not limited to the HTML language, HTML is used only as an example and the systems and methods can be applied to any tag type language.

It is noted that as used in this application, terms such as “component,” “audio,” “display,” “interface, ” and the like are intended to refer to a computer-related entity, either hardware, a combination of hardware and software, software, or software in execution as applied to a mobile communication device. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one mobile communication device and/or distributed between two or more computers, mobile communication devices, and/or modules communicating therewith. Additionally, it is noted that as used in this application, terms such as “system user,” “user,” “operator” and the like are intended to refer to the person operating the computer-related entity referenced above.

As used herein, the term to “infer” or “inference” refer generally to the process of reasoning about or inferring states of the system, environment, user, and/or intent from a set of observations as captured via events and/or data. Captured data and events can include user data, device data, environment data, data from sensors, sensor data, application data, implicit and explicit data, etc. Inference can be employed to identify a specific context or action, or can generate a probability distribution over states, for example. The inference can be probabilistic, that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

It is also noted that the interfaces described herein can include an Audio User Interface (AUI) to interact with the various components for providing network or internet based information to users. This can include substantially any type of application that sends, retrieves, processes, and/or manipulates input data, receives, displays, formats, and/or communicates output data, and/or facilitates operation of the enterprise. For example, such interfaces can also be associated with an engine, editor tool or web browser although other type applications can be utilized. The AUI can include sound generation devices and transmitters for providing the AUI to a device located remotely from the mobile communication device. In addition, the AUI can also include a plurality of other inputs or controls for adjusting and configuring one or more aspects. This can include receiving user commands from a mouse, keyboard, speech input, web site, remote web service and/or other device such as a camera or video input to affect or modify operations of the AUI.

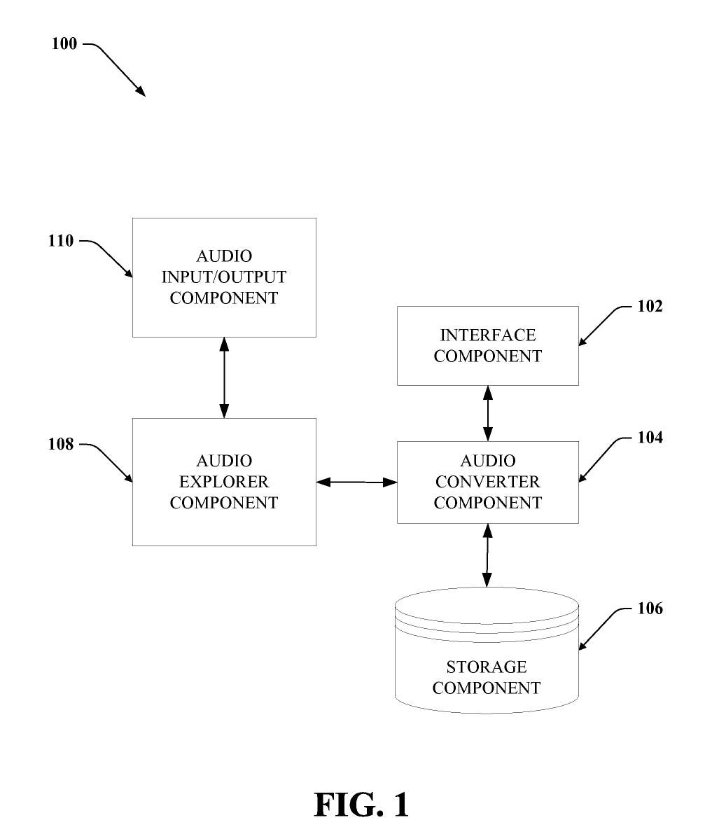

Referring initially to FIG. 1, a mobile communication device 100 for interacting with a network communication system including a cellular network and the internet is depicted. It should be appreciated that even though a mobile communication device can interact with the same information available to a computer connected to the internet, the mobile communication device is limited in its ability to provide an interface for the user to interact with the applications and data available from the network. Mobile communication device 100 addresses this shortcoming by providing a communicative connection to the networked system operated by bidirectional audio. The interface allows for the configuration and interaction of the mobile communication device 100 by way of audio broadcast output from the mobile communication device 100 and commands and other input spoken by the user to the mobile communication device 100. In turn, the mobile communication device 100 converts the spoken commands to text and acts on the textual commands as if they were entered in a traditional fashion of clicking a mouse while hovering over a hyperlink.

It is contemplated that mobile communication device 100 can form at least part of a cellular communication network, but is not limited thereto. For example, the mobile communication device 100 can be employed to facilitate creating a communication network related to a wireless network such as an IEEE 802.11 (a,b,g,n). Mobile communication device 100 includes interface component 102, audio converter component 104, storage component 106, audio explorer component 108, and audio input/output component 110.

The interface component 102 is communicatively connected to Input/Output devices and the communication network. The interface component 102 provides for object or information selection, input can correspond to entry or modification of data. Such input can affect the configuration, audio input, audio output or graphic display of the mobile communication device. For instance, a user can select the audio output to be transmitted to a headset implementing a wireless communication protocol such as Bluetooth. Additionally or alternatively, a user could modify the language map to allow the mobile communication device to accept commands spoken in the German language. By way of example and not limitation, a downloaded email would be read to the user in German and commands to forward the email would be accepted if spoken to the mobile communication device 100 in German. It should be noted that input need not come solely from a user, it can also be provided by other mobile communication devices assuming sufficient security credentials are provided to allow the interaction.

The interface component 102 receives input concerning audible objects and information. Interface component 102 can receive input from a user, where user input can correspond to object identification, selection and/or interaction therewith. Various identification mechanisms can be employed. For example, user input can be based on speaking predefined commands associated with the mobile communication device 100 or the commands can be part of the information downloaded from the network.

The audio converter component 104 provides a parser for locating tags in the data associated with the downloaded item. For example, the parser will identify all of the hyperlinks included in a downloaded web page and create a list of their location for further processing. The parser will also identify formatted text such as bold, underlined or italicized and add the locations of the formatted text to the list of audio enhancements, again for further processing. The audio converter does not require any predefined tags to exist in the downloaded web page and therefore all existing web pages are available for audio conversion. It should be noted that although web pages are the predominant form of downloadable data available for audio conversion, the subject invention is not limited to web pages and can parse and convert any tag type data format.

The audio converter component 104 also provides a tag inserter for processing the list of tag and formatted text locations. The tag inserter inserts audio tags at the locations defined in the list for the particular tag types. After completing the conversion, the audio converter component 104 caches the converted downloaded data to the storage component 106 to optimize performance by retrieving the cached data if the data is downloaded again and has not been modified.

The storage component 106 provides the ability to archive the audio tag database and the programs and services necessary for operation of the mobile communication device 100. As mentioned previously, the converted downloaded tag data is cached to optimized performance regarding revisiting the same location. An algorithm is employed to determine if the downloaded data requires a subsequent parsing or if it may be reused from the cache.

In another aspect, the tag databases are updated as required from server storage locations on the network providing for the evolution of existing tag protocols and the addition of new tag protocols. The storage component 106 also provides for storing the user's configuration choices such as interaction language. For example, the user can configure the mobile communication device to speak and respond to French.

The audio explorer component 108 provides methods and functionality for playing the downloaded tag data converted by the audio converter component 104. For example, in a fashion similar to parsing the data and displaying the formatted text on a display screen, the audio explorer component 108 parses the formatted text, converts the text to speech and then plays the speech to the user through the audio input/output component 110. In another aspect, the user can reply through the audio input output component 110 with selections and commands to the audio explorer component 108. For example, when the audio explorer component 108 plays a web page to the user, the links can be preceded and followed by a tone indicating that the bracketed text is a hyperlink to another web page. The user can speak the hyperlink to the audio explorer component 108 and the audio explorer component 108 will convert the speech to text, look up the hyperlink in the list of links created for the web page and execute the hyperlink to download the selected web page.

In another aspect, the user can select the user's email server and the audio explorer 108 will function as an audio email client. For example, in this capacity the audio explorer will check for newly arrived email for the user and invoke the audio converter component to convert any newly arrived email to the audio email format. The audio explorer will then play the user the list of email currently in the user's audio email inbox. The user can speak the identity of a particular email, either by number, subject or from address and the audio explorer will read the email to the user. The user can then verbally choose to delete, forward or reply to the email. The audio explorer then converts the user's speech to text, formats the email and sends the email to the desired recipients.

The audio input/output component 110 provides the speech based communication interface between the user and the audio explorer. In one embodiment, the mobile communication device 100 has a speaker and a microphone included similar to the design of any cellular telephone. The mobile communication device can also transmit the speech to a remote speaker or headset if the user desires more privacy or to operate in a hands-free type arrangement. In a similar fashion, the user can speak into a wireless microphone that is communicatively connected to the mobile communication device. The audio input/output component 110 can also be adapted to allow for different dialects or accents associated with different geographical regions.

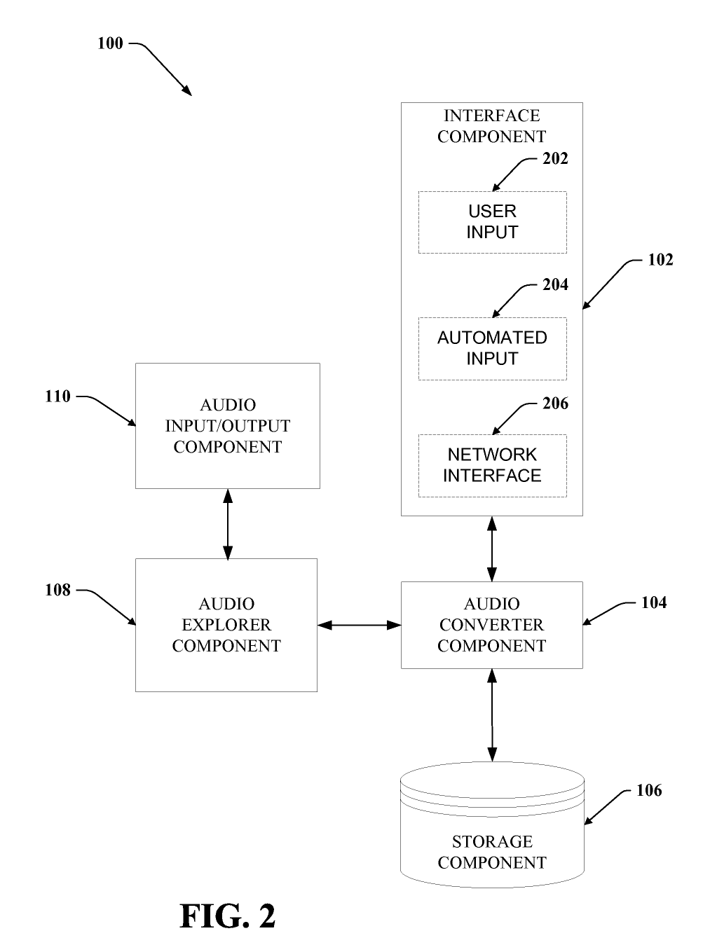

Referring next to FIG. 2, the interface component 102 includes user input component 202, automated input component 204 and network interface component 206. In one aspect, user input component 202 provides the capability for a user to input manual data related to configuring the mobile communication device 100. The user can enter this data either from the keypad attached to the mobile communication device 100 or through speech converted to text commands. For example, the user can use the keypad to select a particular language to accept for voice commands. In another example, the user can speak the commands necessary to place the mobile communication device 100 in a learn mode so the user can teach the mobile communication device the user's specific dialect for command pronunciation.

In another aspect, the automated input component 204 responds to commands received from an external source such as the communication network. As the user and their mobile communication device 100 move about geographically the mobile communication device 100 can receive commands or configuration information automatically. For example, if a network server becomes aware of a system outage such as an email server, the system can automatically command the mobile communication device to update the configuration to use a backup email server until the primary server is back online. In another example, a user's home security system can send the user's mobile communication device 100 a command to verbally advise the user that there is an issue at the user's home requiring the user's immediate attention.

In another aspect of the interface component 102, network interface component 206 provides the hardware and software protocols to interact with different networks supported by the mobile communication device 100. For example, the mobile communication device can communicate over a cellular network with regards to making telephone calls, browsing the internet and communicating with email, text messages or instant messages. In another aspect, network interface component 206 can automatically identify the presence of an acceptable and permitted wireless network and can use the wireless network for tasks such as browsing the internet and communicating with email. The automatic determination of available network communications will optimize the mobile communication device for best performance by balancing usage between the different available networks.

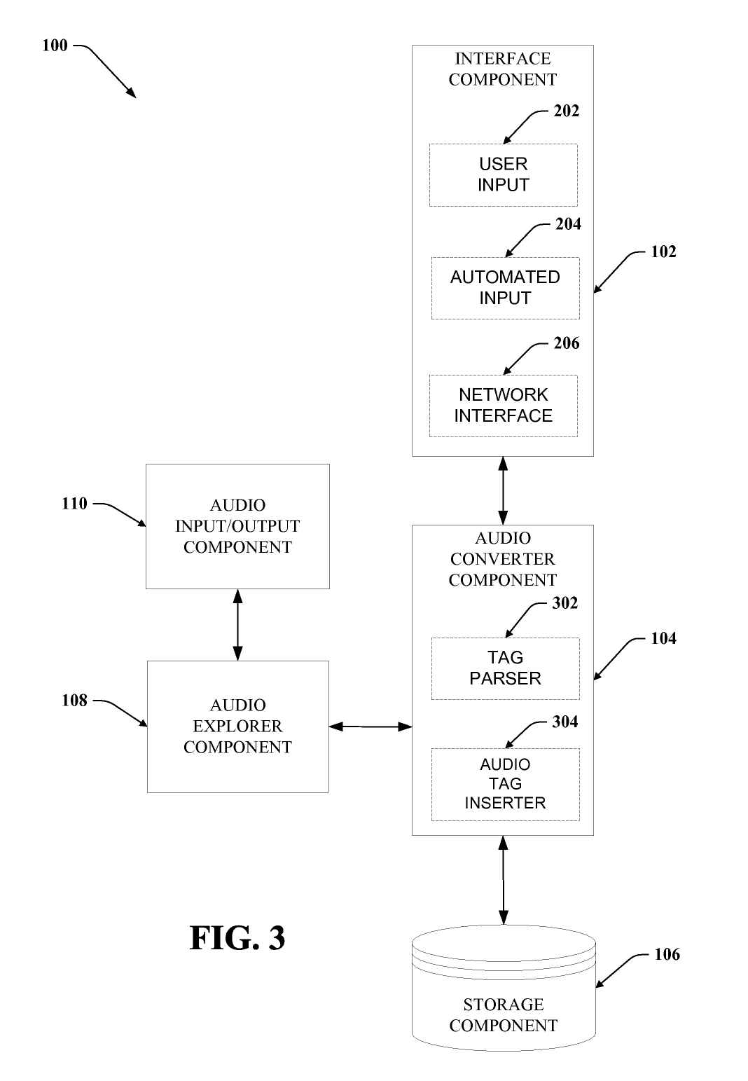

Referring next to FIG. 3, the audio converter component 104 includes a tag parser component 302 and an audio tag inserter component 304. In one aspect, the tag parser component 302 provides for parsing the downloaded tag data and identifying any tags or formatted data requiring the insertion of an audio tag. For example, the tag parser component 302 will detect menu items and hyperlinks embedded in a web page. In another example, the tag parser component 302 will detect bolded text in the body of an email. The tag parser component 302 next creates a list of the identified locations requiring the insertion of an audio tag and provides the list to the audio tag inserter component 304.

In another aspect, the tag parser component 302 can parse a single download with different parsing engines. For example, the download can be a web page containing HTML tags and XML tags. The tag parser component 302 will recognize the transition from one tag structure to another and change parsing engines as required. In another aspect, the tag parser component 302 will accept downloads already containing audio tags and after verifying a properly formatted audio tag file, forward the audio tag file to the audio explorer 108.

In another aspect of the subject invention, the audio tag inserter component 304 provides for interrogating the list of tag locations provided by the tag parser component 302. At each location indicated in the list, the audio tag inserter component 304 will insert an audio tag representing the associated visual tag. After processing the entire list, the audio tag inserter component 304 caches the audio page on the storage component 106 and forwards the audio page to the audio explorer for playing to the user. The provided system and methods allow an audio play of any web page, email or other tag based document with the source of the document being aware of or implementing audio tags. As described previously, this does not preclude the source application form embedding audio tags in the document if the source application so chooses.

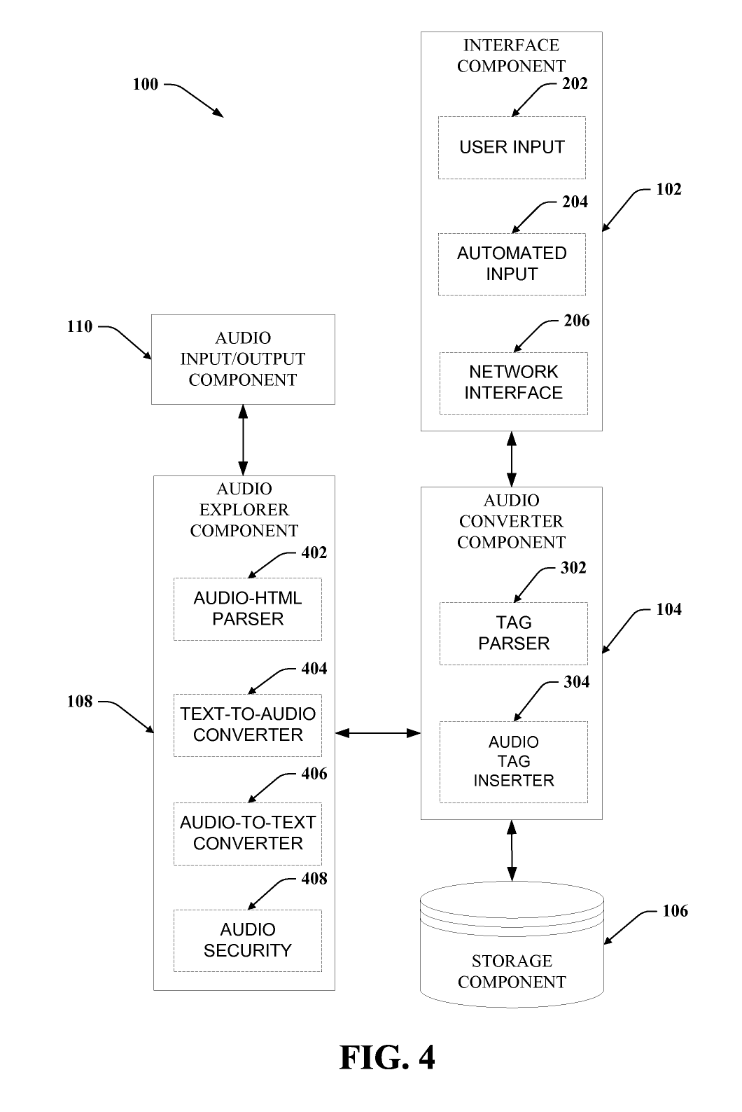

Referring to FIG. 4, the audio explorer component 108 includes audio tag parser component 402, text-to-audio converter component 404, audio-to-text converter component 406 and audio security component 408. In one aspect of the subject invention, the audio tag parser component 402 parses the tag file and plays the audio tags to the user. In another embodiment, the audio tag parser component 402 adjusts the volume of the playback representing the detection of formatted bold audio text. In another aspect of the subject invention, the audio tag parser component plays configured tones before and after a hyperlink, indicating the presence of a hyperlink. It should be noted that the playback association between an audio tag and the audio representation of the tag is configurable by the user. For instance, the user can choose to represent a hyperlink by playing a sound of selected tone and duration before and after the hyperlink is spoken. In another example the user can configure the audio explorer 108 to speak the word “link” or “hyperlink” before and/or after speaking the hyperlink.

In another aspect of the subject invention, the audio tag parser component 402 can refuse to speak certain audio tags because the audio tags require the presentation of specified security credentials before the audio tag parser component 402 allows the playback of the audio tag. For example, the downloaded web page can include private financial information and require the user's security credentials before the information is made available. The audio tag parser component 402 requests permission from the audio security component with regards to disclosing the secure information. If the audio security component 408 authorizes the disclosure then the audio tag parser component instructs the audio explorer component 108 to play the audio tag.

The text-to-audio converter component 404, in another aspect of the subject invention, provides the capability to convert defined blocks of text to speech. For example, a block of text can include information in a textual format on a web page or the description associated with an image inserted in a web page. In another example, the block of text can be the body or the subject line of an email addressed to the user. The text-to-audio converter component 404 is also configurable, allowing the user to select different voices or languages for playback of the audio tags.

The audio-to-text converter component 406, in another aspect of the subject invention, provides the ability for the user to speak to the mobile communication device 100 and have the mobile communication device 100 interpret the user's spoken words as responses to inquiries, commands or selections based on the audio presentations. In a similar fashion to the text-to-audio converter 404, the audio-to-text converter component 406 is configurable by the user with respect to language and command phrases and their meanings. Additionally, the audio-to-text converter component 406 allows the user to pre-record words or phrases intended for commands to allow the mobile communication device 100 to precisely match the user's voice. The user's voice recordings are then archived on storage component 106.

In another aspect of the subject invention, the audio-to-text conversion component 406 allows the user to respond in a freeform fashion to an audio email. For example, the user, after listening to an audio email can speak a command such as “Reply” to instruct the mobile communication device 100 to generate a reply email. After the mobile communication device acknowledges it is ready to accept the email body, the user can speak the body of the email and the audio-to-text conversion component 406 will convert the user's speech to text and insert it in the body of the email. The user can then choose to replay the email and when satisfied with the email contents, instruct the mobile communication device 100 to send the email.

The audio security component 408, in another aspect of the subject invention, provides access security to information designated as requiring the presentation of security credentials before disclosure. For example, the user can instruct the mobile communication device to access the corporate web site, a location requiring a valid password. The audio converter component 104 detects the requirement of a password and instructs the audio explorer component 108 to request the password from the user. The audio explorer component 108 first requests the password for the web site from the audio security component. The audio security component 408 then determines if the user has previously provided a password for this web site. If a password is designated for this web site then the audio security component 408 provides the password to the audio converter component and access is granted. If a password for this site is not available, then the audio explorer requests the password from the user. If the user provides a valid password then access to the web site is granted.

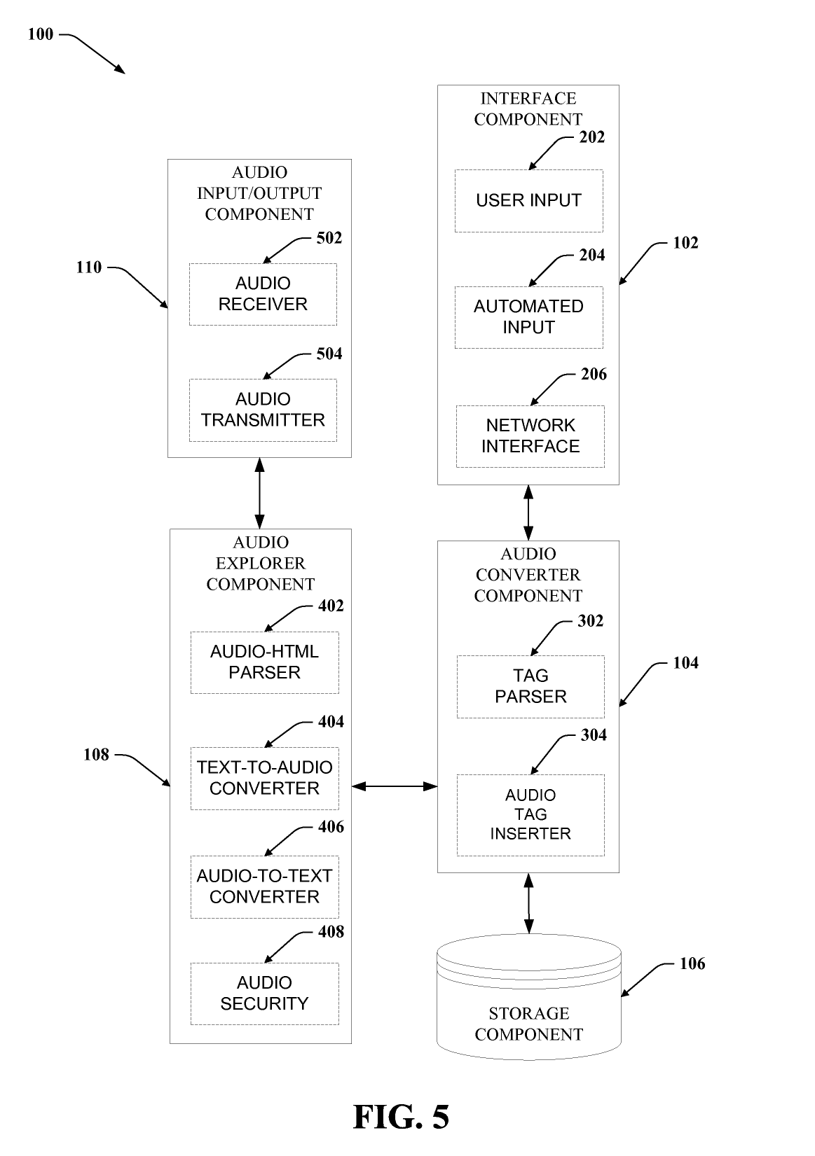

Referring now to FIG. 5, the audio input/output component 110 includes an audio receiver component 502 and an audio transmitter component 504. In one aspect, the audio receiver component 502 allows for the receipt and interpretation of the user's voice. The user can speak directly to the microphone in the mobile communication device 100 or through a remote microphone wirelessly connected to the mobile communication device 100. In another aspect of the subject invention, the user may record a series of commands on the mobile device 100 and schedule them for playback at a later time or based on a particular event such as the receipt of an email from a particular sender. When the scheduled time arrives or the particular event occurs, the audio explorer component 108 executes the commands.

In another aspect of the subject invention, the audio transmitter component 504 provides the mobile communication device the ability to broadcast the audio tags as speech. For example, the audio transmitter component 504 can transmit the audio tags through the speaker attached to the mobile communication device 100. In another embodiment, the audio transmitter can wirelessly transmit the speech to a remote speaker device such as a Bluetooth headphone device. This mechanism allows the user more freedom of movement with regards to carrying the mobile communication device and provides the added security of not allowing others to overhear the subject matter of the communication.

In a specific example, the user may receive an email describing the performance of his retirement investment fund while he is captive in a public location. Although he has the option of not listening to the email until he is in a private location, he can choose to restrict playback of particular items or sources to headphone type listening devices so others in the general area cannot overhear the conveyed information. In another aspect, if the user is in a private location when the communication arrives and it is marked as private listening source only, the user can make the decision to override the privacy component of the communication and play the communication as normal through the mobile communication device local speaker.

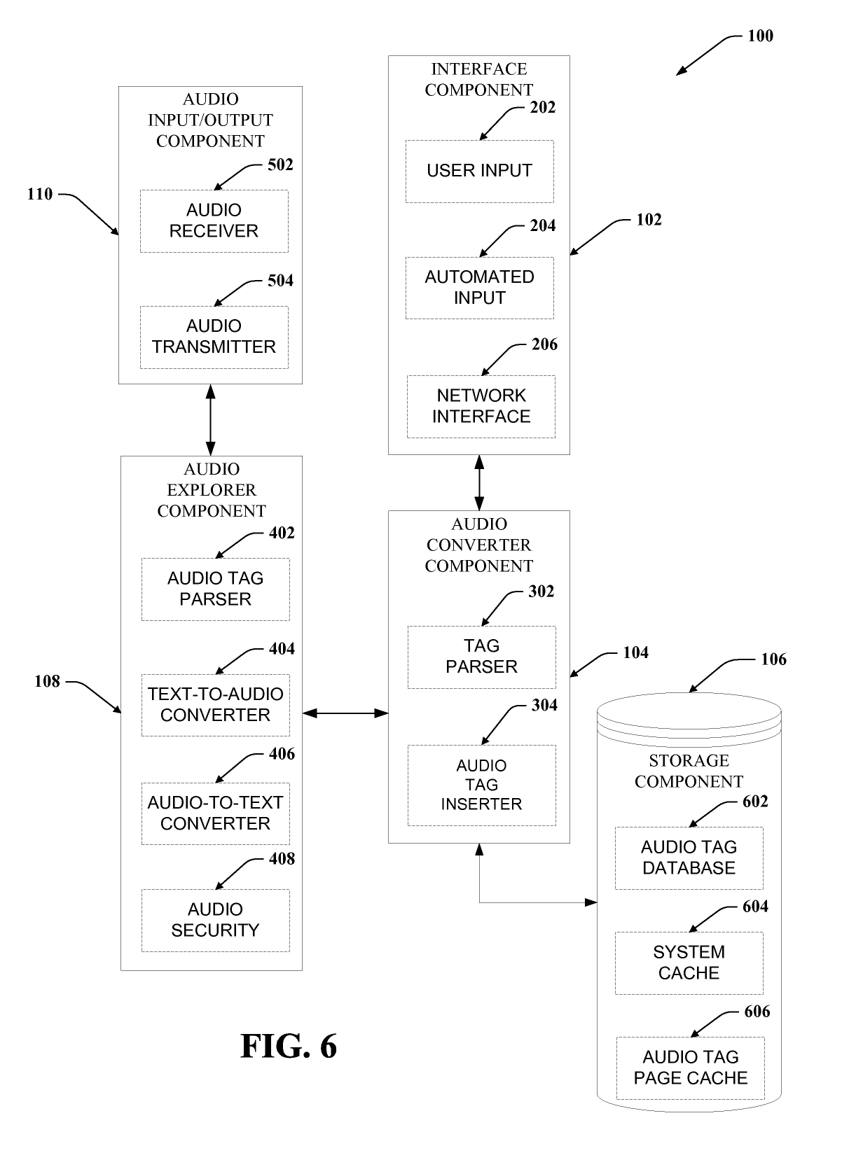

Referring now to FIG. 6, the storage component 106 includes an audio tag database component 602, a system storage component 604 and an audio page cache component 606. Storage component 106 can be any suitable data storage device (e.g., random access memory, read only memory, hard disk, flash memory, optical memory), relational database, XML, media, system, or combination thereof. The storage component 106 can store information, programs, historical process data and the like in connection with the mobile communication device 100. In one aspect, the audio tag database component 602 provides the capability to store a plurality of audio tags for use in parsing downloaded data files and creating audio files for playing by the audio explorer 108. The audio tag database component 602 can be updated from support systems located on the communication network or it can be manually updated at the mobile communication device.

In another aspect, the system storage component 604 provides storage for all the components required to operate the mobile communication device 100. In another aspect, the system storage component 604 provides for maintaining an audit log of all activities conducted by the mobile communication device 100. The logged activities include communication sessions network location and utilization and security credentials provided by users.

The audio page cache component 606, in another aspect of the subject invention, provides for storing downloaded data files after they have been converted to audio pages by the audio converter component 104. The audio page cache component 606 is configurable to maintain cached pages for a specified period of time or until the audio page cache component exceeds the maximum amount of storage space. Each time a new data file is downloaded and parsed, it is compared to the audio pages in the cache and if a match is found then the cached page is used for user playback.

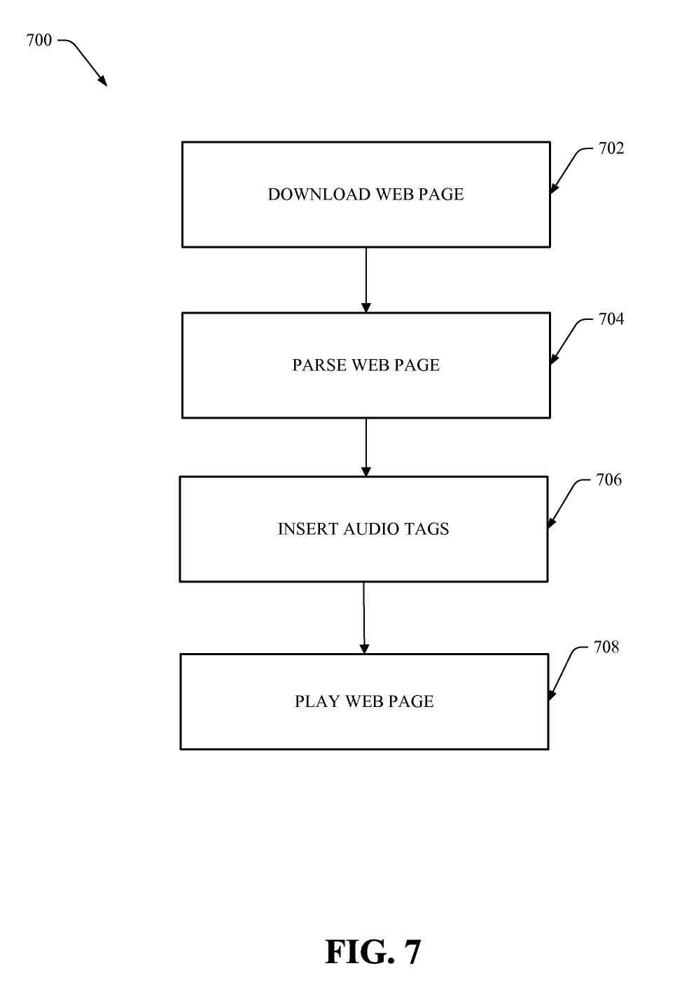

Referring now to FIG. 7, a method 700 of playing a downloaded web page as speech. In one aspect at 702, a web page is downloaded from a user selectable location on the communication network or the internet. It should be noted that although this example uses a web page, the document may also include data from other applications such as an email file from an email server.

In another aspect of the subject invention at 704 of the method 700 of playing a downloaded web page as speech, the downloaded web page is parsed for all tag items and formatted text. As tags and formatted text are identified, the locations of the tags and formatted text are added to a list matching the item to the location in the downloaded data file. If the downloaded data file already contains audio tags then the tag is added to the list but it is marked as already converted. A downloaded data file containing audio tags would resemble a cached audio tag file.

In another aspect at 706 of the method 700 of playing a downloaded web page as speech, audio tags are inserted into the downloaded data file creating an audio tag file. For example, if a web page is downloaded containing a title in bold text a description in underlined text and a hyperlink then several different audio tags are inserted. At the location of the bold title, an audio tag is inserted that increases the volume of the playback in proportion to the size of the text and a tone based on the bold attribute. At the location of the underlined text, an audio tag is inserted that adjusts the tone to the predefined condition for underlined text. At the location of the hyperlink, an audio tag is inserted both before and after the hyperlink. The audio tag can include a tone or a spoken word as a delimiter for the hyperlink.

In another aspect at 708 of the method 700 of playing a downloaded web page as speech, the converted web page is played for the user. Playing, in the context of the subject invention includes parsing the audio tag file, converting the text commands to speech and projecting the speech to the user. The user hears the contents of the downloaded file as a reading of the subject matter with active components such as menu items, formatted text and hyperlinks delimited by configured words or tones. It should be noted that other active components are available limited only by the syntax of the applicable audio tag specification.

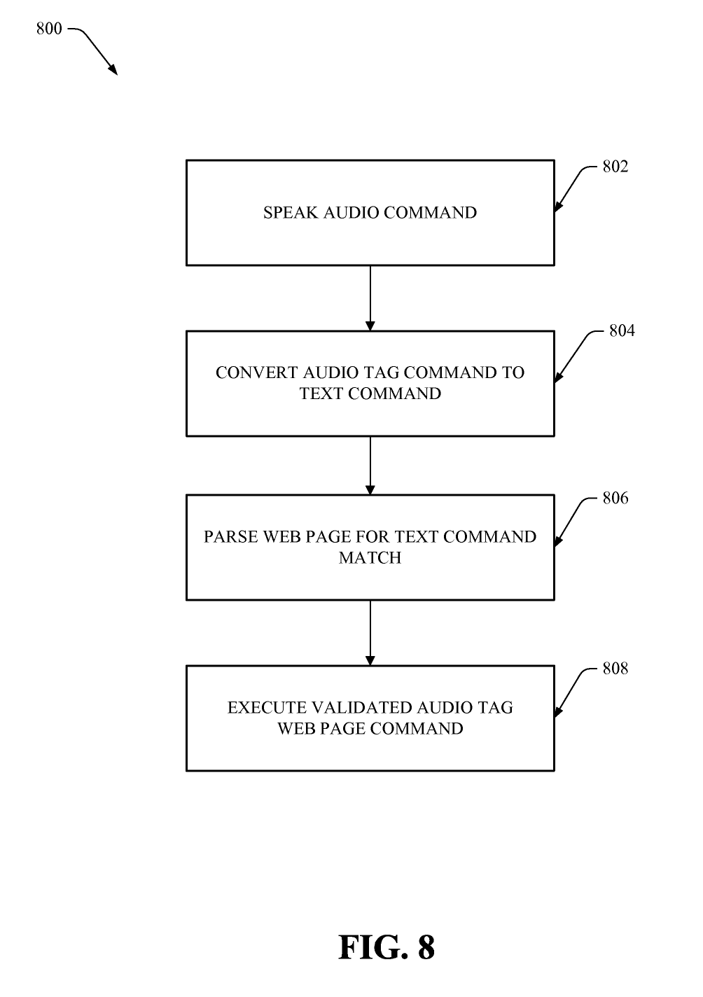

Referring now to FIG. 8, a method 800 is illustrated for executing a user spoken command by a mobile communication device 100. In one aspect of the subject method at 802, the user speaks an audio command to the mobile communication system 100. The user can choose the language, such as English, French, German, etc. that the mobile communication device 100 will understand. The user may also prerecord command words in the user's voice for ease of matching by the mobile communication device 100.

In another aspect at 804, the user's spoken command is converted to a text command. The user can issue one or more commands for conversion to text and when the user indicates the last command has been entered the list of commands are ready for processing. As previously described, the user can speak the commands directly to the microphone on the mobile communication device or through a microphone communicatively coupled to the mobile communication device through a wireless connection.

In another aspect at 806, the applicable web page is parsed to search for matches between the users spoken commands and the available commands defined on the particular web page. Each command spoken by the user and matched to the web page is marked as available for execution. Certain generally available commands such as the command defined for previous page or the command defined to go to the home page are executed regardless of whether a match is found on the currently evaluated web page.

In another aspect at 808, the validated text commands or generally available commands are executed. The command list is executed in the order the validated commands were spoken by the user. If any of the commands require security credentials before or as part of their execution then a verbal request is broadcast to the user to input the appropriate security credentials, such as a password. If the user cannot provide valid security credentials then the command list execution is aborted.

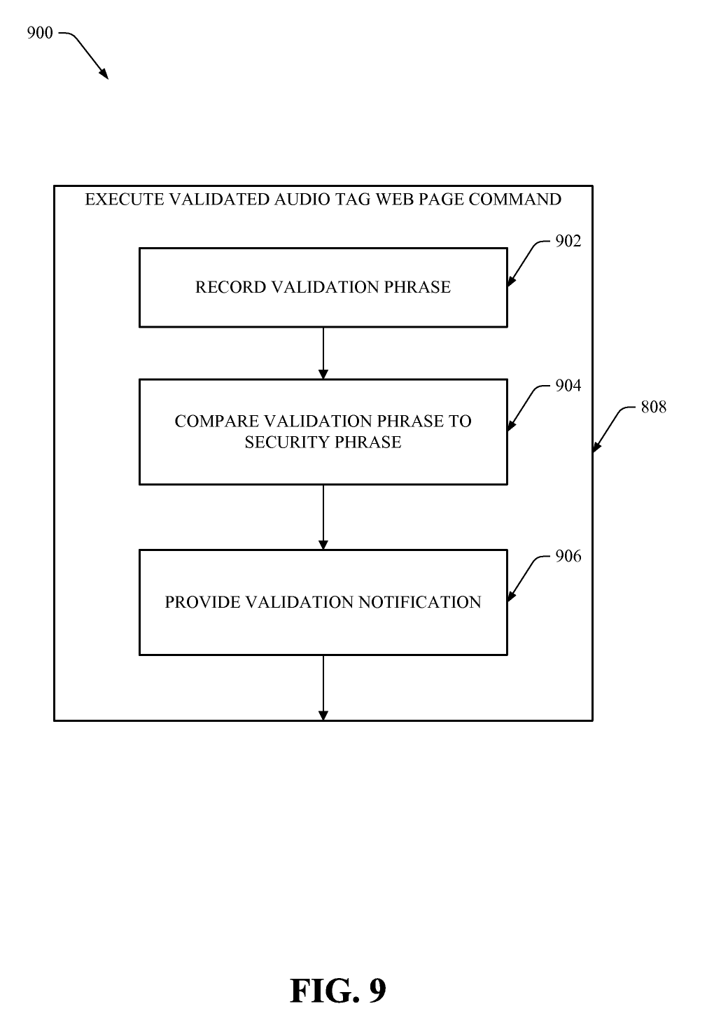

Referring now to FIG. 9, a method 900 illustrates validating user audio commands to a mobile communication device 100 by the audio security component 408. In one aspect of the subject method at 902, the user records the validation word or phrase prior to the first requirement of presenting the user's security credentials. This technique allows the user to encode words, tones, numbers or any other spoken sounds as part of the valid security credentials provided when the mobile communication device is configured.

In another aspect at 904, upon request by the mobile communication device 100, the user provides the security phrase to the mobile communication device 100 for validation before the execution of a command requiring user authorization. The user must provide the security phrase because the validation includes more than just a comparison of the required words and tones, a voice comparison is included to determine if it is the required user speaking the security phrase.

In another aspect at 906, if the mobile communication device 100 determines that the presented security credentials are authentic, i.e. it is the specified user speaking the required security phrase and then notification of authorization is provided to the requester authorizing the execution of the requested command. It should be noted that a remote server can request a particular user's authorization and the notification of authorization, if provided, is transmitted from the user's mobile communication device 100 to the remote server where the command execution occurs.

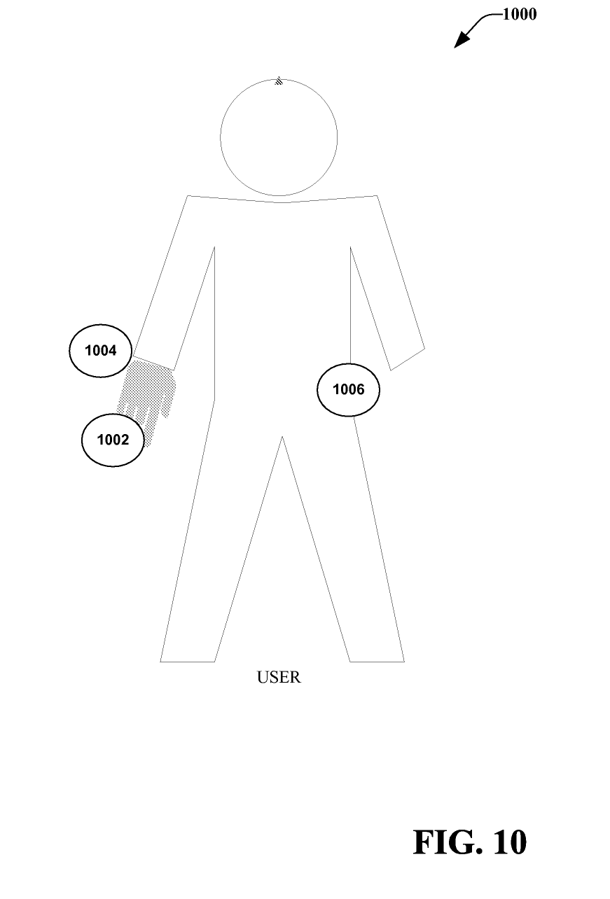

Referring now to FIG. 10, a user 1000 is represented wearing different implementations of a mobile communication device 100. In one aspect, mobile communication device 100 is a ring device 1002. In this configuration, the mobile configuration device does not have a video display or keypad and operates in audio mode only. Connections are provided to attach a keypad for configuration purposes.

In another aspect, a mobile communication device 1004, in a configuration similar to a wrist watch or bracelet provides for the inclusion of a display device and a keypad operated with the use of a stylus. As with the other mobile communication devices 100 however the primary method of user interaction is by audio.

In another aspect, a mobile communication device 1006, in a configuration of a device similar to a pager attached to a belt, includes the ability to locate the geographical position of the user and provide an added dimension of security before performing certain commands. For example, part of the validation sequence in addition to speaking the security phrase can be determining that the user is in a desired location before executing the requested action. In another aspect, the mobile communication device 1006 has a greater battery capacity in this configuration, including a more powerful transmitter allowing mobile communication device 100 of configuration 1006 to operate at greater distances for longer periods of time before requiring a recharge.

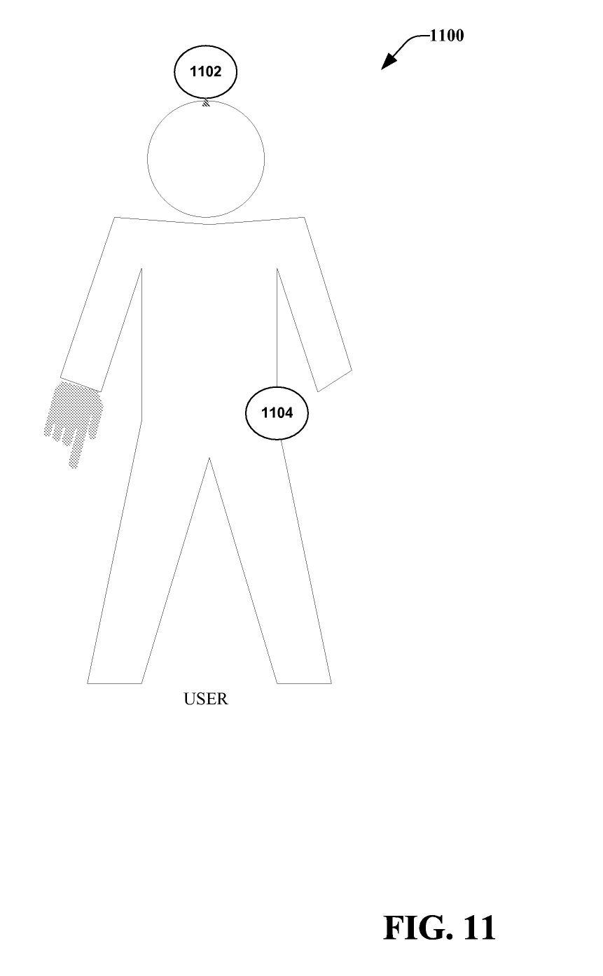

Referring now to FIG. 11, a user 1100 is represented wearing a voice communication apparatus. In one aspect, a headset and microphone 1102 allows the user to send voice commands and data to the mobile communication device 100. The user can receive an audible feedback tone or voice to confirm receipt of his communication and listen to audio from the mobile communication device.

In another aspect, a user is represented wearing a device similar in physical configuration to a mobile communication device 1006 except communication device 1104 is a relay transmitter and receiver. Communication device 1104 also contains a more powerful battery and transmitter allowing the user to travel greater distances from the communication network for greater periods of time before requiring a recharge of communication unit 1104 is required.

Although not required, the claimed subject matter can partly be implemented via an operating system, for use by a developer of services for a device or object, and/or included within application software that operates in connection with one or more components of the claimed subject matter. Software may be described in the general context of computer executable instructions, such as program modules, being executed by one or more computers, such as clients, servers, mobile devices, or other devices. Those skilled in the art will appreciate that the claimed subject matter can also be practiced with other computer system configurations and protocols, where non-limiting implementation details are given.

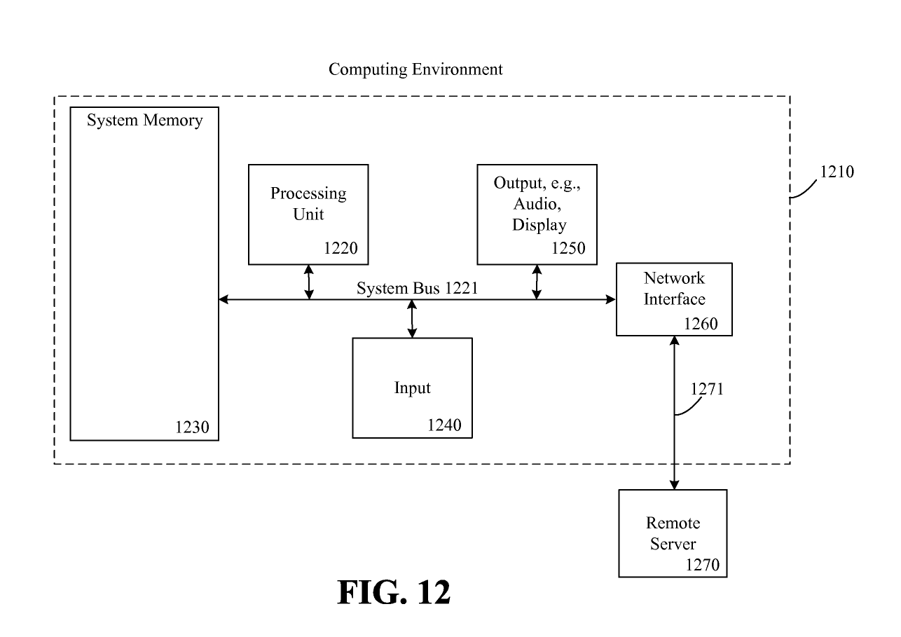

FIG. 12 thus illustrates an example of a suitable computing system environment 1200 in which the claimed subject matter may be implemented, although as made clear above, the computing system environment 1200 is only one example of a suitable computing environment for a mobile device and is not intended to suggest any limitation as to the scope of use or functionality of the claimed subject matter. Further, the computing environment 1200 is not intended to suggest any dependency or requirement relating to the claimed subject matter and any one or combination of components illustrated in the example operating environment 1200.

With reference to FIG. 12, an example of a remote device for implementing various aspects described herein includes a general purpose computing device in the form of a computer 1210. Components of computer 1210 can include, but are not limited to, a processing unit 1220, a system memory 1230, and a system bus 1021 that couples various system components including the system memory to the processing unit 1220. The system bus 1221 can be any of several types of bus structures including a memory bus or memory controller, a peripheral bus, and a local bus using any of a variety of bus architectures.

Computer 1210 can include a variety of computer readable media. Computer readable media can be any available media that can be accessed by computer 1210. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a modulated data signal such as a carrier wave or other transport mechanism and can include any suitable information delivery media.

The system memory 1230 can include computer storage media in the form of volatile and/or nonvolatile memory such as read only memory (ROM) and/or random access memory (RAM). A basic input/output system (BIOS), containing the basic routines that help to transfer information between elements within computer 1210, such as during start-up, can be stored in memory 1230. Memory 1230 can also contain data and/or program modules that are immediately accessible to and/or presently being operated on by processing unit 1220. By way of non-limiting example, memory 1230 can also include an operating system, application programs, other program modules, and program data.

The computer 1210 can also include other removable/non-removable, volatile/nonvolatile computer storage media. For example, computer 1210 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1221 through a non-removable memory interface such as an interface, and a magnetic disk drive or optical disk drive can be connected to the system bus 1221 by a removable memory interface, such as an interface.

A user can enter commands and information into the computer 1210 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1220 through user input 1240 and associated interface(s) that are coupled to the system bus 1221, but can be connected by other interface and bus structures, such as a parallel port, game port or a universal serial bus (USB). A graphics subsystem can also be connected to the system bus 1221. In addition, a monitor or other type of display device can be connected to the system bus 1221 via an interface, such as output interface 1250, which can in turn communicate with video memory. In addition to a monitor, computers can also include other peripheral output devices, such as speakers and/or a printer, which can also be connected through output interface 1250.

The computer 1210 can operate in a networked or distributed environment using logical connections to one or more other remote computers, such as remote server 1270, which can in turn have media capabilities different from device 1210. The remote server 1270 can be a personal computer, a server, a router, a network PC, a peer device or other common network node, and/or any other remote media consumption or transmission device, and can include any or all of the elements described above relative to the computer 1210. The logical connections depicted in FIG. 12 include a network 1271, such local area network (LAN) or a wide area network (WAN), but can also include other networks/buses. Such networking environments are commonplace in homes, offices, enterprise-wide computer networks, intranets and the Internet.

When used in a LAN networking environment, the computer 1210 is connected to the LAN 1271 through a network interface or adapter. When used in a WAN networking environment, the computer 1210 can include a communications component, such as a modem, or other means for establishing communications over the WAN, such as the Internet. A communications component, such as a modem, which can be internal or external, can be connected to the system bus 1221 via the user input interface at input 1240 and/or other appropriate mechanism. In a networked environment, program modules depicted relative to the computer 1210, or portions thereof, can be stored in a remote memory storage device. It should be appreciated that the network connections shown and described are exemplary and other means of establishing a communications link between the computers can be used.

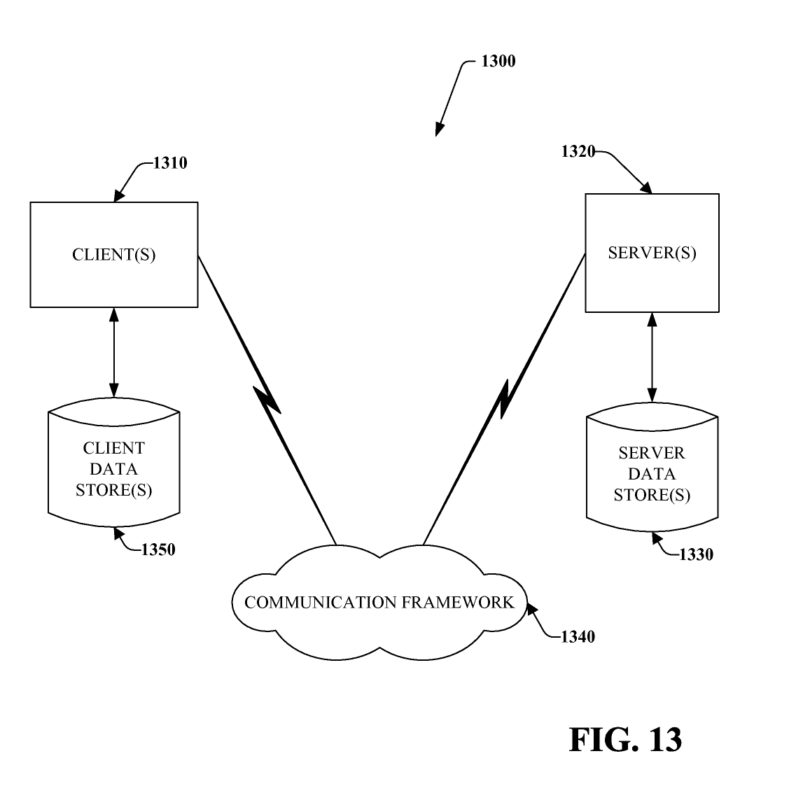

FIG. 13 is a schematic block diagram of a sample-computing environment 1300 within which the disclosed and described components and methods can be used. The system 1300 includes one or more client(s) 1310. The client(s) 1310 can be hardware and/or software (for example, threads, processes, computing devices). The system 1300 also includes one or more server(s) 1320. The server(s) 1320 can be hardware and/or software (for example, threads, processes, computing devices). The server(s) 1320 can house threads or processes to perform transformations by employing the disclosed and described components or methods, for example. Specifically, one component that can be implemented on the server 1320 is a security server. Additionally, various other disclosed and discussed components can be implemented on the server 1320.

One possible means of communication between a client 1310 and a server 1320 can be in the form of a data packet adapted to be transmitted between two or more computer processes. The system 1300 includes a communication framework 1340 that can be employed to facilitate communications between the client(s) 1310 and the server(s) 1320. The client(s) 1310 are operably connected to one or more client data store(s) 1350 that can be employed to store information local to the client(s) 1310. Similarly, the server(s) 1320 are operably connected to one or more server data store(s) 1330 that can be employed to store information local to the server(s) 1340.

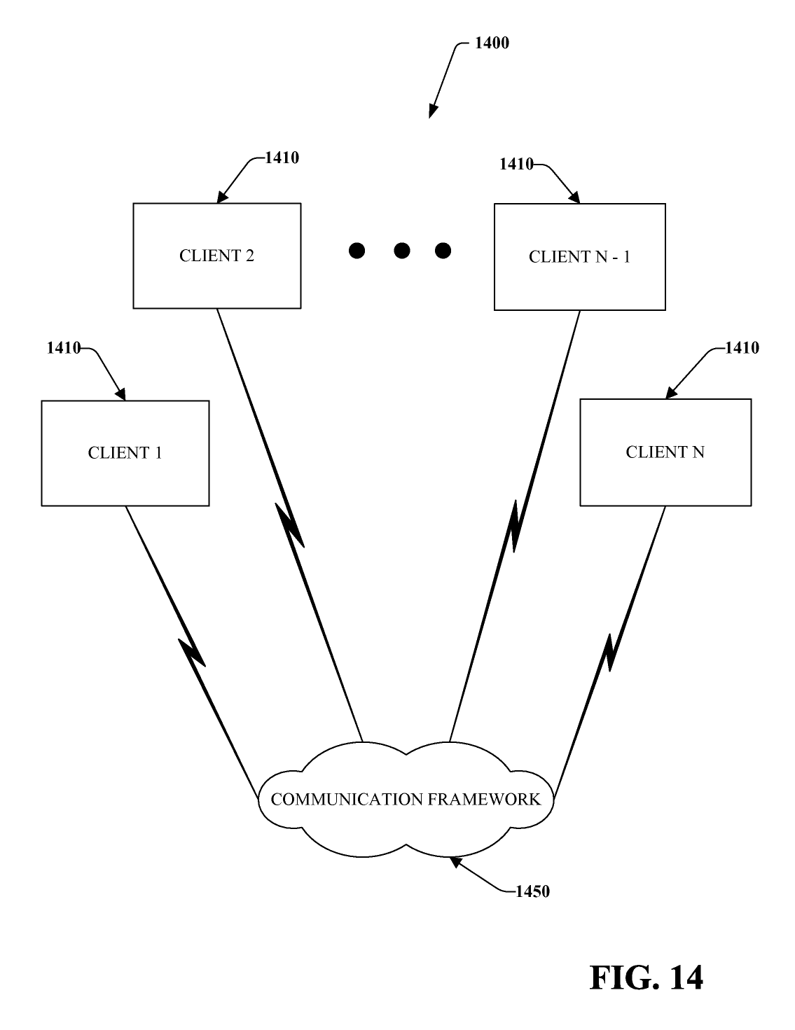

Referring again to the drawings, FIG. 14 illustrates an embodiment of the subject invention where a plurality of client systems 1310 can operate collaboratively based on their communicative connection. For example, as described previously, a mobile communication device 100 can transmit a request for command execution to a plurality of mobile communication devices 100 to perform a mass upgrade or reset of the entire communication network system. In another example, the mobile communication device 100 can operate in a series fashion, allowing a users' communication received by mobile communication device client 1 to transmit the information to mobile communication device 100 client 2 which proceeds to transfer the information to mobile communication device 100 client N-1 and in a similar fashion transmits the information to mobile communication device 100 client N where the information is transmitted to a server 1320.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described above, methodologies that can be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, no single embodiment shall be considered limiting, but rather the various embodiments and their equivalents should be construed consistently with the breadth, spirit and scope in accordance with the appended claims.

While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

What is claimed is:

1. A mobile communication device allowing a user to browse network or internet based data by listening to the mobile communication device read the network or internet based data, the apparatus comprising:
an interface component for exchanging data with a network or the internet;
an audio converter component for parsing the network or internet based data and inserting audio tags;
an audio explorer component for converting the audio tags and the text of the network or internet based data to speech; and
an audio input/output component for playing the speech to the user and accepting speech from the user.

2. The system of claim 1, the network or internet based data is web sites and their associated web pages selected with the mobile communication device by the user.

3. The system of claim 1, the network or internet based data is email and the associated attached files selected with the mobile communication device by the user.

4. The system of claim 1, the audio converter can convert data containing tags from different tag specifications.

5. The system of claim 1, the audio converter can represent formatted text comprising bold, underlined and italicized text as different tones or volume levels during playback to the user.

6. The system of claim 1, the audio explorer is configurable to read the network or internet based data in a user selectable language.

7. The system of claim 1, the audio explorer can request the user to speak security credentials for validation before playing the network or internet based data.

8. The system of claim 1, the user can control the reading of the network or internet based data by speaking commands to the mobile communication device.

9. The system of claim 1, further comprising a storage component for archiving a plurality of audio tag specification databases.

10. The system of claim 9, the audio converter component can cache the converted network or internet based data for reuse if the user revisits the same network or internet based data location.

11. The system of claim 9, the user can archive the security credentials on the storage component allowing the audio explorer to automatically provide the security credentials when required.

12. The system of claim 1, the audio input/output component can transmit the audio to a remote wireless headset for private playing of the network or internet based data.

13. The system of claim 8, the user can verbally command the audio explorer to select a hyperlink associated with the current network or internet based data and navigate to a different page of network or internet based data.

14. The system of claim 3, the user can verbally command the audio explorer to convert and play the file(s) attached to the email.

15. The system of claim 3, the user can verbally command the audio explorer to reply to the email, including a verbal response from the user, converted to text and included in the reply.

16. A method of interacting with network or internet based data using speech as a medium of communication, the method comprising:
receiving data from the network or the internet;
converting the data by inserting audio tag descriptors into the data;
providing the converted data to an audio explorer; and
allowing an audio explorer to play the converted to a user.

17. The method of claim 16, the data received from the network or the internet is a user selected web page.

18. The method of claim 16, the data received from the network or the internet is an email.

19. A mobile communication device, the apparatus including a processor and memory, comprising:
means for exchanging data with a network or the internet;
means for converting the network or internet based data to audio tag data; and
means for playing the audio tag data to a user.

20. The system of claim 19, further comprising:
means accepting verbal commands from the user;
means for validating the identity of the user; and
means for archiving audio tag data and user security credentials.
